(19) United States
(12) Patent Application Publication
(10) Pub. No.: US 2006/0007451 A1
(43) Pub. Date: Jan. 12, 2006

(54) Sensor head of reflective optical encoder

(75) Inventor: Takeshi Ito, Hino-shi (JP)

Correspondence Address: Scully, Scott, Murphy & Presser, 400 Garden City Plaza, Garden City, NY, 11530-3319, US

(73) Assignee: OLYMPUS CORPORATION, TOKYO (JP)

(21) Appl. No.: 11/175,865

(22) Filed: Jul. 6, 2005

(30) Foreign Application Priority Data
Jul. 9, 2004 (JP) 2004-203753

(51) Int. Cl. G01B 11/14

(52) U.S. Cl. 356/616

(57) ABSTRACT

A sensor head in a reflective optical encoder has a light source that projects a light beam to be applied to a scale, and two semiconductor substrates. The semiconductor substrates respectively have photodetectors that detect the light beam reflected and modulated by an optical pattern of the scale and electrical pads that are configured to be connected to an external circuit, and at least one of the semiconductor substrates has an electrical circuit that processes signals output from the photodetectors. The sensor head also has electric wiring lines that electrically connect the electrical pads of the two semiconductor substrates, and a package that contains the light source and semiconductor substrates.

### CROSS-REFERENCE TO RELATED APPLICATIONS

This application is based upon and claims the benefit of priority from the prior Japanese Patent Application No. 2004-203753, filed Jul. 9, 2004, the entire contents of which are incorporated herein by reference.

### BACKGROUND OF THE INVENTION

1. Field of the Invention

The present invention relates to an optical encoder.

2. Description of the Related Art

Currently, so-called encoders such as optical and magnetic encoders have been used to detect displacement amounts in a linear direction for machine tool stages, three-dimensional measurement instruments, and the like, and to detect rotational angles for servo motors and the like.

An optical encoder generally comprises a scale fixed to a displacement measurement target such as a stage and a sensor head to detect the displacement of the scale. The scale has a movement detection pattern whose optical characteristics change periodically in the moving direction. The sensor head has a light-emitting unit to apply a light beam to the scale and a detector to detect the light beam modulated by the scale. The moving amount of the scale is calculated on the basis of a change in intensity of the light beam detected by the detector.

An optical encoder has characteristics such as high precision, high resolution, noncontact, and high electromagnetic interference resistance, and hence is used in various fields. As encoders demanding high precision and high resolution, in particular, optical encoders are most popular.

### BRIEF SUMMARY OF THE INVENTION

The present invention is directed to a sensor head that is combined with a scale having an optical pattern to constitute a reflective optical encoder. The sensor head according to the present invention has a light source that projects a light beam to be applied to the scale, and two semiconductor substrates. The semiconductor substrates respectively have photodetectors that detect the light beam reflected and modulated by the optical pattern of the scale and electrical pads that are configured to be connected to an external circuit, and at least one of the semiconductor substrates has an electrical circuit that processes signals output from the photodetectors. The sensor head also has electric wiring lines that electrically connect the electrical pads of the two semiconductor substrates and a package that contains the light source and semiconductor substrates.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a reflective optical encoder according to the first embodiment of the present invention;

FIG. 2 is a sectional view taken along the line II-II of the reflective optical encoder shown in FIG. 1;

FIG. 3 is a view, seen from the scale side, of the sensor head of the reflective encoder shown in FIG. 1;

FIG. 4 shows the circuit configuration of the sensor head shown in FIG. 3;

FIG. 5 is a plan view of the scale shown in FIG. 1;

FIG. 6 shows an A-phase signal, B-phase signal, and Z-phase signal detected by the sensor head;

FIG. 7 shows different electric wiring lines that may be employed in place of the electric wiring lines shown in FIG. 4;

FIG. 8 shows the concept of the basic arrangement of a transmissive optical encoder that uses a Talbot image;

FIG. 9 shows another light source using an LED that may be employed in place of, e.g., the light source shown in FIG. 3;

FIG. 10 is a perspective view of a sensor head in a reflective optical encoder according to the second embodiment of the present invention;

FIG. 11 is a sectional view of the reflective optical encoder including the sensor head shown in FIG. 10;

FIG. 12 is a plan view, seen from the scale side, of the sensor head shown in FIG. 10;

FIG. 13 is a sectional view of a sensor head in a reflective optical encoder according to the third embodiment of the present invention;

FIG. 14 is a plan view, seen from the scale side, of the sensor head shown in FIG. 13; and

FIG. 15 is a plan view, seen from the scale side, of a portion of a sensor head according to a modification of the third embodiment, the portion including a transparent member and semiconductor substrates.

### DETAILED DESCRIPTION OF THE INVENTION

Embodiments of the present invention will be described below with reference to the views of the accompanying drawing.

### First Embodiment

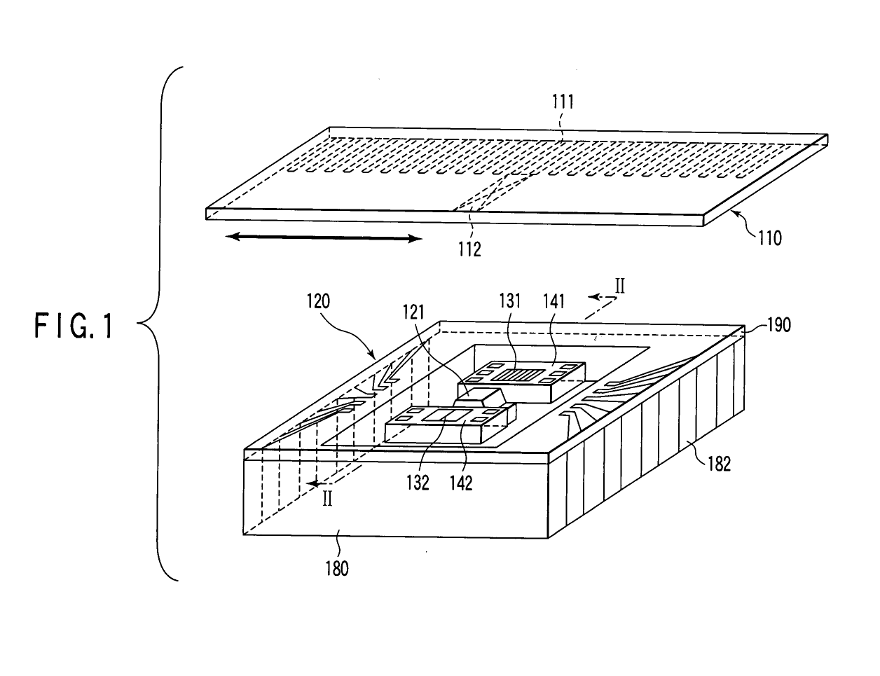

FIG. 1 shows a reflective optical encoder according to the first embodiment of the present invention. As shown in FIG. 1, the reflective optical encoder comprises a scale 110 and a sensor head 120. The scale 110 is attached to a movement detection target, which can move relative to the sensor head 120. The sensor head 120 detects the movement of the scale 110. The scale 110 can move with respect to the sensor head 120 in directions of arrows.

As shown in FIG. 5, the scale 110 has two types of optical patterns, i.e., a movement detection pattern 111 and a reference position detection pattern 112. The movement detection pattern 111 and reference position detection pattern 112 are respectively formed on two tracks that extend adjacent to each other in the moving direction. The movement detection pattern 111 has a periodic structure in the moving direction. The reference position detection pattern 112 is provided at one portion in the moving direction.

The sensor head 120 comprises a light source 121 for projecting a light beam to be applied to the scale 110, two semiconductor substrates 141 and 142, and a package containing the light source 121 and semiconductor substrates 141 and 142. The package comprises a box-like housing 180 and a lid member 190 having a portion that transmits light. The lid member 190 is attached to the housing 180 to close the opening of the housing 180. The housing 180 has electrode terminals 182 that are configured to be connected to an external circuit.

The semiconductor substrate 141 has a moving amount detection photodetector 131 for detecting the light beam reflected and modulated by the movement detection pattern 111 of the scale 110. The semiconductor substrate 142 has a reference position detection photodetector 132 for detecting the light beam reflected and modulated by the reference position detection pattern 112 of the scale 110.

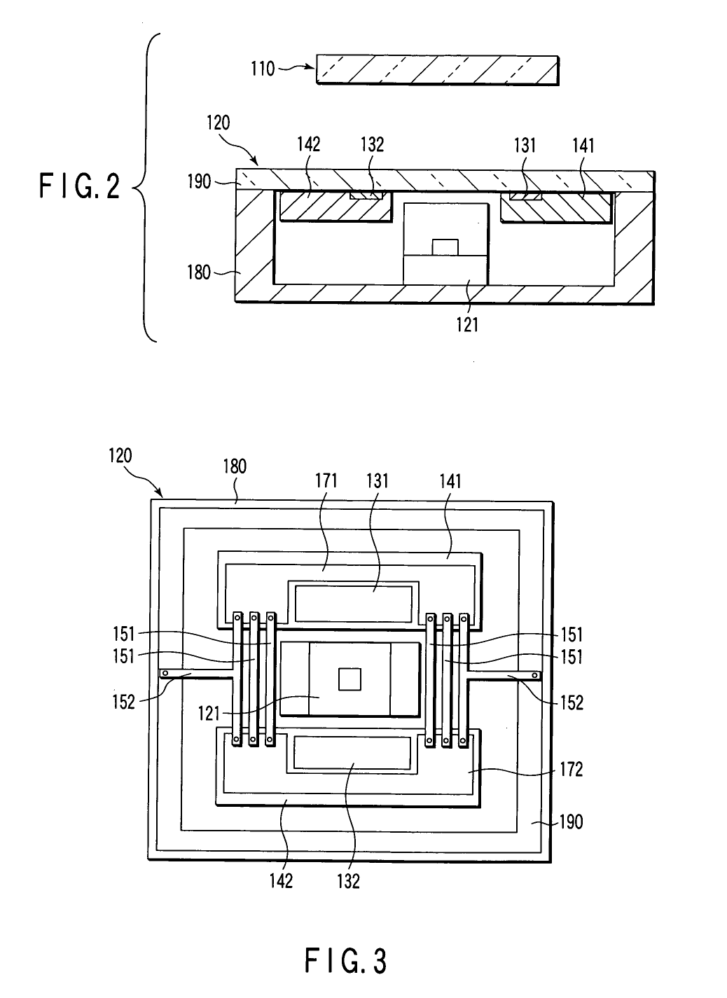

FIG. 2 is a sectional view taken along the line II-II of the reflective optical encoder shown in FIG. 1. As shown in FIG. 2, the light source 121 is fixed to the housing 180. The semiconductor substrates 141 and 142 are fixed to the lid member 190 by, e.g., flip-chip bonding.

FIG. 3 is a view, seen from the scale side, of the sensor head of the reflective encoder shown in FIG. 1. As shown in FIG. 3, the semiconductor substrates 141 and 142 having the moving amount detection photodetectors 131 and 132, respectively, are arranged on the two sides of the light source 121 in a direction substantially perpendicular to the moving direction of the scale 110. The semiconductor substrate 141 is provided with an electrical circuit 171 on a part of its region excluding the moving amount detection photodetector 131. The semiconductor substrate 142 is provided with an electrical circuit 172 on a part of its region excluding the reference position detection photodetector 132. The electrical circuits 171 and 172 on the semiconductor substrates 141 and 142 are electrically connected to each other through electric wiring lines 151 and 152.

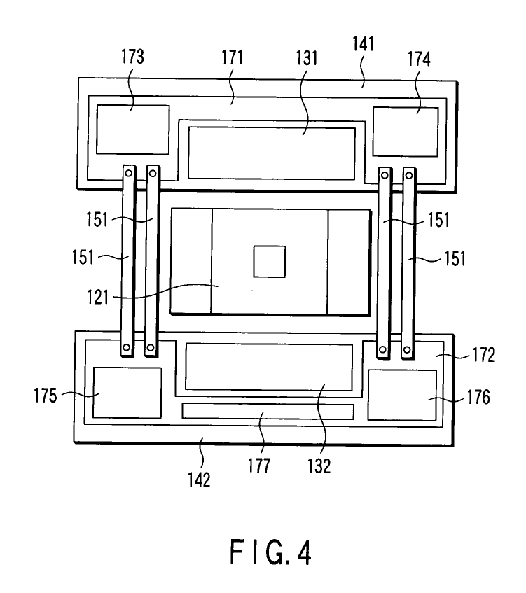

FIG. 4 shows the circuit configuration of the sensor head shown in FIG. 3. As shown in FIG. 4, the electrical circuit 171 on the semiconductor substrate 141 includes an I/V converting circuit 173 that I/V-converts a photocurrent output from the moving amount detection photodetector 131 and a light source driving circuit 174 for driving the light source 121. The electrical circuit 172 on the semiconductor substrate 142 includes an I/V converting circuit 177 that I/V-converts a photocurrent output from the reference position detection photodetector 132, a digital circuit 175 that pulses the I/V-converted analog signal, and an interpolator 176 that interporates a periodical analog signal accompanying the movement of the scale 110 and outputs it as a pulse.

These electrical circuits are arranged considering their characteristics.

It is not preferable to transmit output signals from the moving amount detection photodetector 131 and reference position detection photodetector 132 to another semiconductor substrate as photocurrents. This is because the photocurrents may be largely influenced by noise from the connecting wiring lines. For this reason, the I/V converting circuit 173 is formed on the semiconductor substrate 141 that has the moving amount detection photodetector 131. The I/V converting circuit 177 is formed on the semiconductor substrate 142 that has the reference position detection photodetector 132.

A moving amount detection signal output from the I/V converting circuit 173 reflects the movement of the scale 110. A reference position detection signal output from the I/V converting circuit 177 reflects the presence/absence of the reference position of the scale 110.

If these signals (the moving amount detection signal and reference position detection signal) are superposed with noise from the digital circuit 175 and interpolator 176, it appears as a sharp change. In other words, the noise from the digital circuit 175 and interpolator 176 causes a sharp change in the moving amount detection signal and reference position detection signal. A similar sharp change is also caused by the reciprocal movement of the scale 110 within a short period of time. In other words, the reciprocal movement of the scale 110 within the short period of time also causes a sharp change in the moving amount detection signal and reference position detection signal.

In detection of the reference position, the reciprocal movement of the scale 110 within a short period of time is not significant. Accordingly, a sharp change in the reference position detection signal may be neglected as noise. In detection of the moving amount, the reciprocal movement of the scale 110 within a short period of time is the information that should be detected. Accordingly, a sharp change in the moving amount detection signal cannot be neglected as noise.

In other words, the moving amount detection signal output from the I/V converting circuit 173 is readily susceptible to noise from the digital circuit 175 and interpolator 176. Therefore, the I/V converting circuit 173 is desirably formed on a semiconductor substrate that is different from the semiconductor substrate on which the digital circuit 175 and interpolator 176 are formed. The reference position detection signal output from the I/V converting circuit 177 is not readily susceptible to noise from the digital circuit 175 and interpolator 176. Therefore, if the I/V converting circuit 177 is formed on the same semiconductor substrate on which the digital circuit 175 and interpolator 176 are formed, it will not cause much trouble.

For this reason, the digital circuit 175 and interpolator 176 are formed on the semiconductor substrate 142 that is different from the semiconductor substrate 141 that has the I/V converting circuit 173. The I/V converting circuit 177 is formed on the semiconductor substrate 142 that has the digital circuit 175.

The light source driving circuit 174 is not likely to generate noise and accordingly arranged on the semiconductor substrate 141 that has the moving amount detection photodetector 131. The light source driving circuit 174, however, generates heat and may negligibly influence the circuit characteristics depending on the position where it is mounted. Therefore, the position to mount the light source driving circuit 174 must be selected carefully.

Referring back to FIG. 3, the electric wiring lines 151 and 152 are formed on that surface of the lid member 190 which faces the semiconductor substrates 141 and 142. The two electrical circuits 171 and 172 are electrically connected to each other through the electric wiring lines 151 and 152. The electric wiring lines 151 only connect the electrical circuits 171 and 172 and are not exposed outside the package. The electric wiring lines 152 are connected to the electrode terminals 182 formed on the housing 180 and configured to be connected to the external circuit. The electrical circuits 171 and 172 are designed to be operated by the same driving voltage Vcc. Hence, a ground voltage Vgnd and the driving voltage Vcc from the external circuit are applied to the electrode terminals 182 of the package. The electric wiring lines 152 from the electrode terminals 182 branch as the electric wiring lines 152 shown in FIG. 3 and extend to the two electrical circuits 171 and 172.

The electric wiring lines formed on the lid member 190 include not only the electric wiring lines 151 that merely connect the electrical circuits 171 and 172 and the electric wiring lines 152 that connect the electrical circuits 171 and 172 and are configured to be connected to the external circuit through the package but also electric wiring lines or the like that extend from the electrical circuit 171 or the electrical circuit 172 or both, as needed, to the package but not to the other one.

The operation of the reflective encoder will be described.

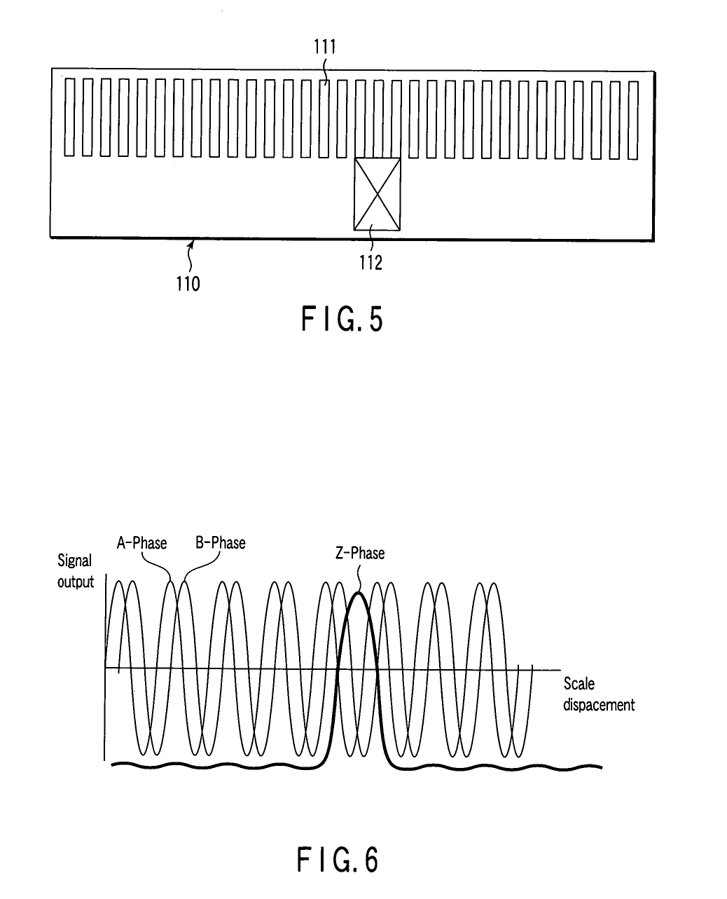

Referring to FIG. 1, part of the light beam projected from the light source 121 is reflected and modulated by the movement detection pattern 111 on the scale 110 and enters the moving amount detection photodetector 131. The intensity of the light beam entering the moving amount detection photodetector 131 changes periodically in accordance with the movement of the movement detection pattern 111. Hence, the moving amount detection photodetector 131 outputs a signal current that changes substantially periodically in accordance with the movement of the scale 110 to the I/V converting circuit 173 in the electrical circuit 171. The I/V converting circuit 173 I/V-converts the input signal current into a voltage signal. This voltage signal contains periodical signals called A- and B-phase signals the phases of which are different from each other by 90°, as shown in FIG. 6.

Part of the light beam projected from the light source 121 is applied to that track on the scale 110 which the reference position detection pattern 112 is formed on. When the scale 110 is at the reference position, the reference position detection pattern 112 is located on the optical path of the light beam. The light beam reflected by the reference position detection pattern 112 enters the reference position detection photodetector 132. When the scale 110 is not at the reference position, the reference position detection pattern 112 is off the optical path of the light beam. A very small quantity of light beam reflected by the surface of the scale 110 enters the reference position detection photodetector 132. The reference position detection photodetector 132 outputs a signal current that changes almost in a binary manner in accordance with the presence/absence of the reference position detection pattern 112 to the I/V converting circuit 177 in the electrical circuit 172. The I/V converting circuit 177 I/V-converts the input signal current into a voltage signal. This voltage signal is a so-called Z-phase signal and shows a high output voltage, as shown in FIG. 6, when the scale 110 is located near the reference position. Therefore, whether or not the scale 110 is located at the reference position can be determined on the basis of the Z-phase signal.

The A- and B-phase signals output from the I/V converting circuit 173 of the electrical circuit 171 are input to the digital circuit 175 in the electrical circuit 172 through the electric wiring lines 151 or 152 and converted into pulses. The Z-phase signal output from the I/V converting circuit 177 in the electrical circuit 172 is also input to the digital circuit 175 and pulsed.

According to this embodiment, the electrical circuits to be formed on the two semiconductor substrates 141 and 142 are arbitrarily distributed between the empty regions of the two semiconductor substrates 141 and 142 considering various respects, e.g., the functions, roles, and circuit feature sizes of the electrical circuits, and whether or not each circuit affects the other electrical circuits as a noise source. With this arrangement, the electrical circuits to be mounted on the semiconductor substrates can be optimized, and the qualities of the electrical circuits can be improved. More specifically, the I/V converting circuit 173 outputs the moving amount detection signal that is readily susceptible to the noise from the digital circuit 175 and interpolator 176. The I/V converting circuit 173 is formed on the semiconductor substrate 141 that is different from the semiconductor substrate 142 that has the digital circuit 175 and interpolator 176. This can minimize the influence on the I/V converting circuit 173. Thus, a circuit configuration that is not influenced by noise as a whole can be obtained.

The electrical circuits on the two semiconductor substrates 141 and 142 are connected in the package to decrease the number of terminals that serve for connection with the external circuit, e.g., a power supply.

Since the electrical circuits 171 and 172 on the semiconductor substrates 141 and 142 are electrically connected to each other through the electric wiring lines 151 and 152, the electrical circuits 171 and 172 can share a reference current generation circuit and reference voltage generation circuit. That is, the electrical circuits 171 and 172 can share a reference signal (e.g., a reference voltage or reference current). Therefore, the circuit feature size can be decreased. One reference voltage and one reference current can be shared by circuits so that stable circuit operation can be expected.

From the above description, downsizing, cost reduction, and high performance of the reflective optical encoder are enabled.

According to this embodiment, the sensor head 120 has the two semiconductor substrates 141 and 142. The sensor head 120 may further comprise another semiconductor substrate that has an electrical circuit. The electrical circuit on this additional semiconductor substrate may be electrically connected to the electrical circuits 171 and 172 on the semiconductor substrates 141 and 142.

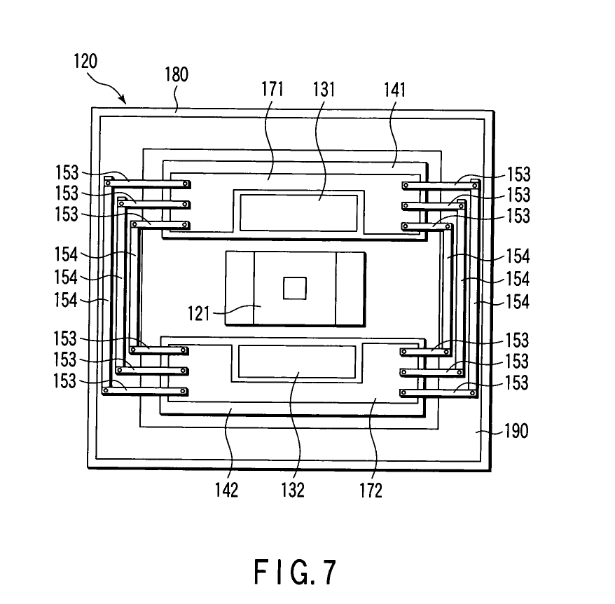

According to this embodiment, the electric wiring lines 151 and 152 that electrically connect the electrical circuits 171 and 172 on the semiconductor substrates 141 and 142 are wiring patterns formed on the surface of the lid member 190, as shown in FIG. 3. The electric wiring lines 151 and 152 may be of any type as far as they can be connected in the package. For example, as shown in FIG. 7, desired terminals of the electrical circuits 171 and 172 may be electrically connected to each other by using electric wiring lines 153 formed on the lid member 190 and electric wiring lines 154 formed on the housing 180. Furthermore, the electric wiring lines 154 may be formed in the housing 180.

According to this embodiment, the light beam that is projected from the light source 121 and then directly reflected by the scale 110 is detected. To further improve the performance, a so-called Talbot image may be employed.

A Talbot image will be described. For the sake of simplicity, the following description will be made on the assumption of a transmissive encoder. However, the same argument holds for a reflective encoder.

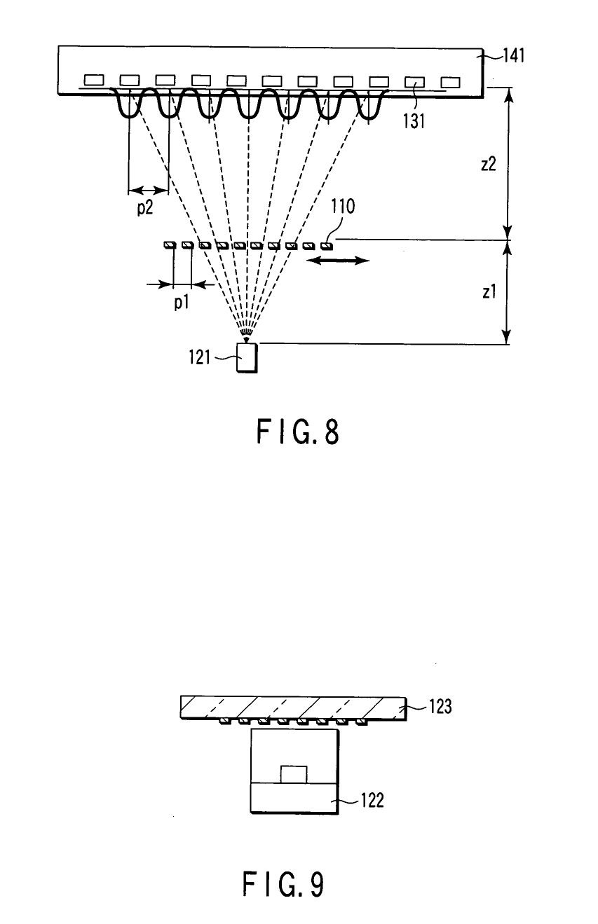

FIG. 8 shows the concept of the basic arrangement of a transmissive optical encoder that uses a Talbot image. Referring to FIG. 8, assume that z1 is the distance between the light source 121 and the movement detection pattern 111 of the scale 110, z2 is the distance between the movement detection pattern 111 of the scale 110 and the moving amount detection photodetector 131, p1 is the pitch of the scale pattern, and p2 is the pitch of a Talbot image projected onto the light-receiving surface of the moving amount detection photodetector 131.

When z1 and z2 satisfy the relation represented by the following equation (1), a bright and dark pattern similar to the scale pattern is known to be projected on the moving amount detection photodetector 131. The bright and dark pattern is called the Talbot image.
(1/z1)+(1/z2)=λ/(k(p1)²) (1)
where λ is the wavelength of the light beam projected from the light source 121, and k is an integer.

To form a Talbot image, the light source 121 must substantially be a point light source. As a substantial point light source, an edge emitting laser, surface-emitting laser, current confinement type LED, or the like can be used.

As shown in FIG. 9, the light source 121 may comprise an ordinary LED 122 in place of a substantial point light source. In this case, a transparent plate 123 having a slit is arranged on the optical path along which a light beam projected from the LED 122 is directed to the scale 110. The slit may have a single aperture, or apertures that are periodically arranged at a predetermined period. With this arrangement, even with an ordinary LED having a short coherence length, a bright and dark pattern similar to a scale pattern, like a Talbot image, can be obtained. The slit may be formed, with the same method as that for the electric wiring lines, on that portion of the lid member 190 which is located on the optical path along which the light beam projected from the LED 122 is directed to the scale.

The pitch of the Talbot image projected onto the moving amount detection photodetector 131 can be calculated by the following equation (2):
p2=p1×(z1+z2)/z1 (2)

By using the Talbot image, a high-performance optical encoder can be formed with a comparatively simple arrangement.

### Second Embodiment

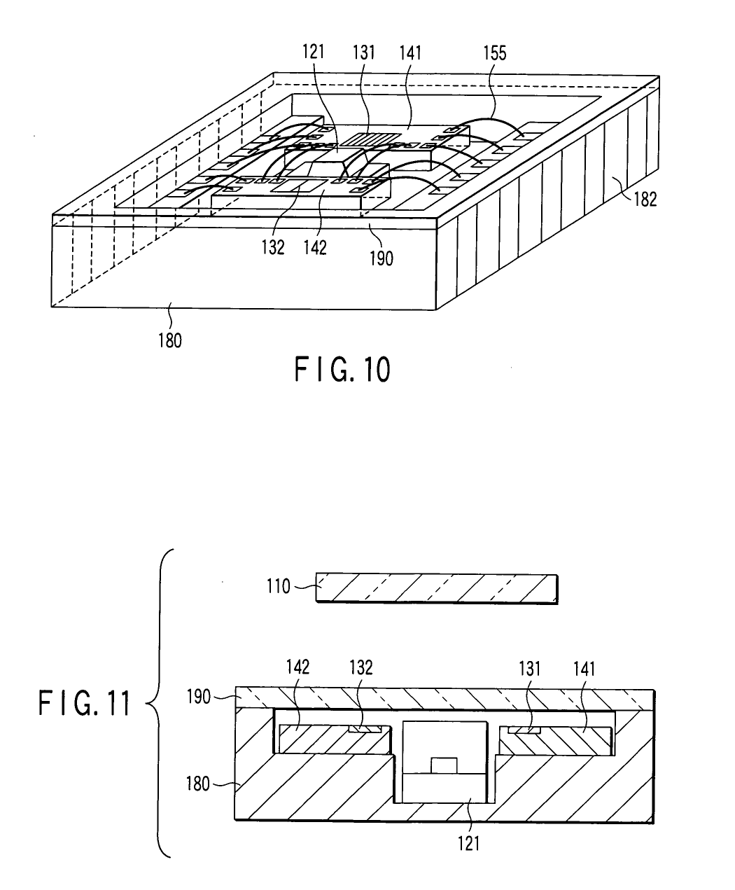

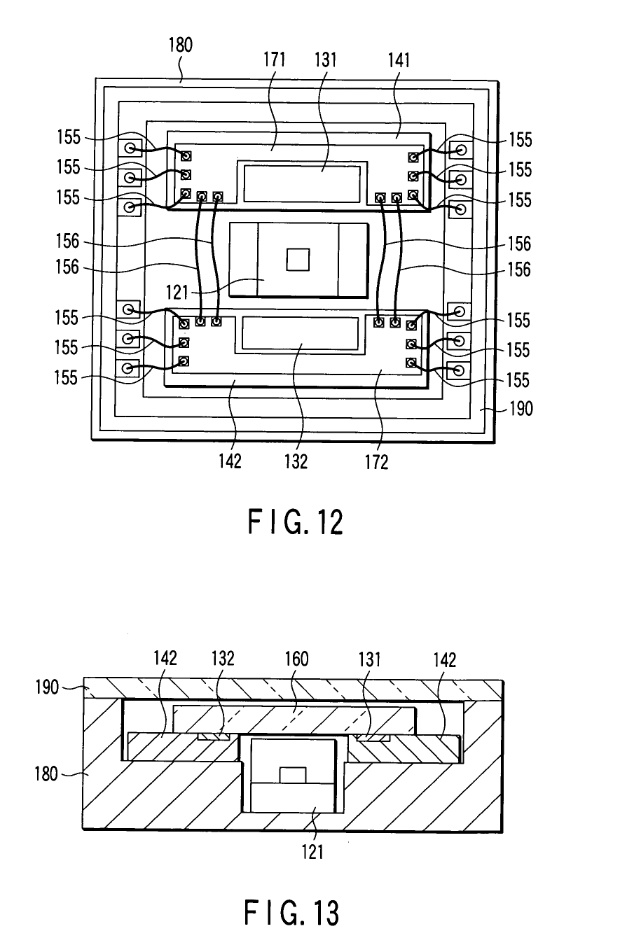

FIG. 10 is a perspective view of a sensor head in a reflective optical encoder according to the second embodiment of the present invention. FIG. 11 is a sectional view of the reflective optical encoder including the sensor head shown in FIG. 10. The section of FIG. 11 corresponds to the section of FIG. 2. FIG. 12 is a plan view, seen from the scale side, of the sensor head shown in FIG. 10. Referring to FIGS. 10, 11, and 12, members indicated by the same reference numerals as those shown in FIGS. 1 and 2 are similar members, and a detailed description thereof will be omitted.

The basic arrangement and operation of the reflective optical encoder of the second embodiment are similar to those of the reflective optical encoder of the first embodiment. A description will be made on portions that are different from their equivalents in the first embodiment.

As shown in FIGS. 10 and 11, a light source 121 and semiconductor substrates 141 and 142 are all fixed to a housing 180. The electrodes on the semiconductor substrates 141 and 142 are electrically connected to the electrodes on the housing 180 through bonding wires 155.

The housing 180 has a cavity to attach the light source 121, and rest-shaped portions to attach the semiconductor substrates 141 and 142. As shown in FIG. 11, the light source 121, a moving amount detection photodetector 131, and a reference position detection photodetector 132 are arranged so that the upper end of the light source 121 and the upper surfaces of the photodetectors 131 and 132 are substantially leveled with each other.

As shown in FIG. 12, two electrical circuits 171 and 172 are electrically connected to each other through bonding wires 156. In other words, the electric wiring lines that connect the two electrical circuits 171 and 172 comprise the bonding wires 156.

With this arrangement, a compact, high-performance encoder can be provided technically easily.

According to this embodiment, the electric wiring lines that connect the two electrical circuits 171 and 172 are the bonding wires 156. Alternatively, these electric wiring lines may be electric wiring lines formed on the surface of or in the housing 180.

### Third Embodiment

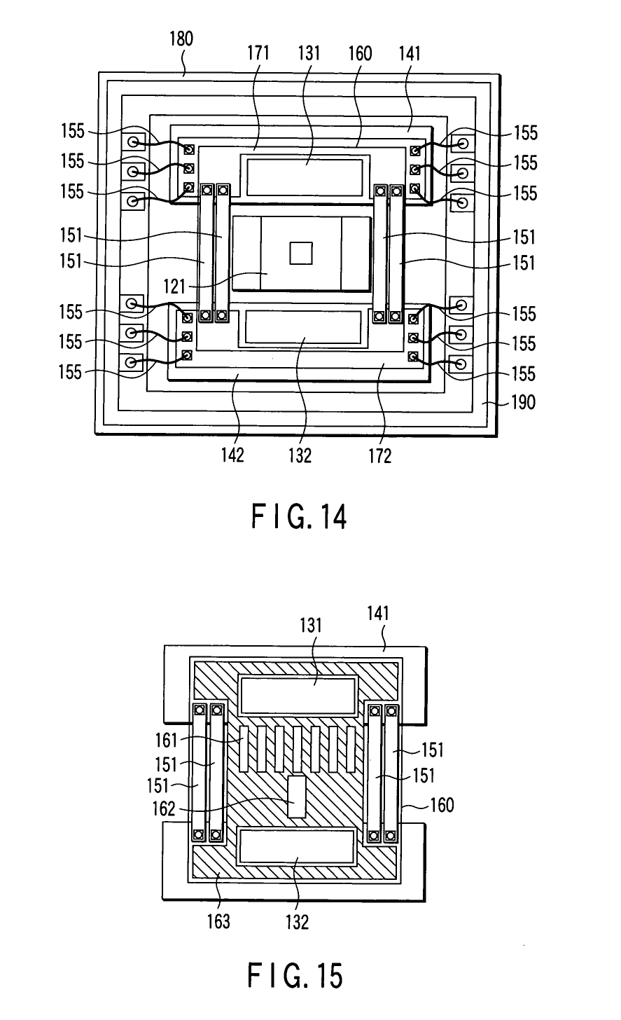

FIG. 13 is a sectional view of a sensor head in a reflective optical encoder according to the third embodiment of the present invention. FIG. 14 is a plan view, seen from the scale side, of the sensor head shown in FIG. 13. The section of FIG. 13 corresponds to the section of FIG. 2. Referring to FIGS. 13 and 14, members indicated by the same reference numerals as those shown in FIGS. 1 and 2 are similar members, and a detailed description thereof will be omitted.

The basic arrangement and operation of the reflective optical encoder of the third embodiment are similar to those of the reflective optical encoder of the second embodiment. A description will be made on portions that are different from their equivalents in the second embodiment.

As shown in FIG. 13, the sensor head of this embodiment has a transparent member 160. The transparent member 160 is located between a light source 121 and a lid member 190, and its two ends are respectively supported by semiconductor substrates 141 and 142.

As shown in FIG. 14, the transparent member 160 comprises electric wiring lines 151 on its surface that faces the semiconductor substrates 141 and 142. The electric wiring lines 151 connect electrical circuits 171 and 172 to each other.

With this arrangement, wire bonding need not be performed across the two semiconductor substrates 141 and 142, and accordingly the electric wiring lines can be easily formed and connected simultaneously.

In this embodiment, a slit may be formed in the transparent member 160, and detection using a Talbot image, which is described in the first embodiment, can be performed.

FIG. 15 is a plan view, seen from the scale side, of a portion of a sensor head using a Talbot image, as a modification of the third embodiment, including the transparent member 160 and semiconductor substrate 141 and 142. According to this modification, slit apertures 161 and 162 and a light-shielding portion 163 are formed in the transparent member 160. The slit apertures 161 and 162 are located on an optical path along which a light beam projected from the light source 121 is directed to the scale 110. No light-shielding portions but apertures are formed above the moving amount detection photodetector 131 and reference position detection photodetector 132.

With this arrangement, a Talbot image can be formed and detected easily. Therefore, a compact, low-cost, and higher-performance reflective optical encoder can be formed.

In all the embodiments described above, the photodetectors on the semiconductor substrates 141 and 142 are respectively a moving amount detection photodetector and reference position detection photodetector. Alternatively, the both photodetectors may be moving amount detection photodetectors, or photodetectors to detect periodic patterns having different pitches as in, e.g., a vernier absolute encoder.

In all the embodiments described above, by using an LED as the light source 121, both the requirements of low cost and high performance can be met. By using an RCLED (Resonant Cavity LED) or SLD (Super Luminescent Diode) as the light source 121, due to its further excellent coherency, the characteristics of the encoder can be further improved. In addition, by using various types of light sources such as a surface-emitting laser, edge emitting laser, current confinement type LED, or the like, an encoder can be formed in accordance with a purpose.

Although the embodiments of the present invention have been descried with reference to the views of the accompanying drawing, the present invention is not limited to these embodiments and may be variously modified or changed within the spirit and scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sensor head that is combined with a scale having an optical pattern to constitute a reflective optical encoder comprising:
a light source that projects a light beam to be applied to the scale;
two semiconductor substrates that respectively have photodetectors that detect the light beam reflected and modulated by the optical pattern of the scale and electrical pads that are configured to be connected to an external circuit, at least one of the two semiconductor substrates having an electrical circuit that processes signals output from the photodetectors;
electric wiring lines that electrically connect the electrical pads of the two semiconductor substrates; and
a package that contains the light source and semiconductor substrates.

2. A head according to claim 1, wherein the electric wiring lines include an electric wiring line that transmits a signal a signal from one of the photodetectors on the two semiconductor substrates to the electrical circuit on the other semiconductor substrate.

3. A head according to claim 1, wherein the two semiconductor substrates respectively have electrical circuits that respectively process the signals output from the photodetectors.

4. A head according to claim 3, wherein the electric wiring lines include an electric wiring line that allows to be shared a reference signal for the electrical circuits on the semiconductor substrates.

5. A head according to claim 3, wherein one of the photodetectors comprises a moving amount detection photodetector that detects a signal in accordance with movement of the scale, the two semiconductor substrates comprise a first semiconductor substrate that has the moving amount detection photodetector and a second semiconductor substrate, an electrical circuit of the first semiconductor substrate includes an analog circuit that processes a current signal output from the moving amount detection photodetector to output an analog signal, and an electrical circuit of the second semiconductor substrate includes a pulse circuit that pulses the analog signal to output a digital signal.

6. A head according to claim 3, wherein one of the photodetectors comprises a moving amount detection photodetector that detects a signal in accordance with movement of the scale, the two semiconductor substrates comprise a first semiconductor substrate that has the moving amount detection photodetector and a second semiconductor substrate, an electrical circuit of the first semiconductor substrate includes an analog circuit that processes a current signal output from the moving amount detection photodetector to output an analog signal, and an electrical circuit of the second semiconductor substrate includes a interpolator that interpolates the analog signal.

7. A head according to claim 3, wherein one of the photodetectors comprises a moving amount detection photodetector that detects a signal in accordance with movement of the scale, the two semiconductor substrates comprise a first semiconductor substrate that has the moving amount detection photodetector and a second semiconductor substrate, an electrical circuit of the first semiconductor substrate includes an analog circuit that processes a current signal output from the moving amount detection photodetector to output an analog signal, and an electrical circuit of the second semiconductor substrate includes a pulse circuit that pulses the analog signal to output a digital signal and a interpolator that interpolates the analog signal.

8. A head according to claim 3, wherein the two semiconductor substrates comprise a first semiconductor substrate and a second semiconductor substrate, the photodetector on the first semiconductor substrate comprises a moving amount detection photodetector that detects a signal in accordance with movement of the scale, and the photodetector on the second semiconductor substrate comprises a reference position detection photodetector that detects a signal in accordance with a reference position of the scale.

9. A head according to claim 8, wherein the electrical circuit of the first semiconductor substrate includes a first analog circuit that processes a periodic signal output from the moving amount detection photodetector, and the electrical circuit of the second semiconductor substrate includes a second analog circuit that processes the reference position signal output from the reference position detection photodetector and a pulse circuit that pulses the periodic signal output from the first analog circuit.

10. A head according to claim 8, wherein the electrical circuit of the first semiconductor substrate includes a first analog circuit that processes a periodic signal output from the moving amount detection photodetector, and the electrical circuit of the second semiconductor substrate includes a second analog circuit that processes the reference position signal output from the reference position detection photodetector and a interpolator that interpolates the periodic signal output from the first analog circuit.

11. A head according to claim 8, wherein the electrical circuit of the first semiconductor substrate includes a first analog circuit that processes a periodic signal output from the moving amount detection photodetector, and the electrical circuit of the second semiconductor substrate includes a second analog circuit that processes the reference position signal output from the reference position detection photodetector, a pulse circuit that pulses the periodic signal output from the first analog circuit, and a interpolator that interpolates the periodic signal output from the first analog circuit.

12. A head according to claim 3, wherein the two semiconductor substrates respectively have ground terminals and power supply terminals that drive the electrical circuit, the package has terminals configured to be connected to an external circuit, and the electric wiring lines have an electric wiring line that electrically connects the power supply terminals in the package and an electric wiring line that electrically connects the ground terminals in the package, the electric wiring line that connects the power supply terminals and the electric wiring line that connects the ground terminals being connected to the terminals of the package that is configured to be connected to the external circuit.

13. A head according to claim 8, wherein the two semiconductor substrates are arranged on two sides of the light source in a direction substantially perpendicular to a moving direction of the scale.

14. A head according to claim 3, wherein the package has a box-like housing and a lid member having a light-transmitting portion, the light source is fixed to the housing, the semiconductor substrates are fixed to the lid member, and at least some of the electric wiring lines are formed on the lid member.

15. A head according to claim 3, further comprising a slit on an optical path along which the light beam projected from the light source is directed to the scale.

16. A head according to claim 3, wherein at least one of the electric wiring lines is not exposed to an outside of the package.

17. A sensor head that is combined with a scale having an optical pattern to constitute a reflective optical encoder comprising:
a light source for projecting a light beam to be applied to the scale;
two semiconductor substrates each having a photodetector for detecting the light beam reflected and modulated by the optical pattern of the scale and electrical pads for connecting an external circuit, at least one of the two semiconductor substrates having an electrical circuit for processing signals output from the photodetectors;
electric wiring lines electrically connecting the electrical pads of the two semiconductor substrates; and
a package containing the light source and semiconductor substrates.

18. A head according to claim 17, wherein each of the two semiconductor substrates has an electrical circuit for processing the signal output from the photodetector thereon.

19. A head according to claim 18, wherein the two semiconductor substrates comprise a first semiconductor substrate and a second semiconductor substrate, the photodetector on the first semiconductor substrate comprises a moving amount detection photodetector for detecting a signal in accordance with movement of the scale, and the photodetector on the second semiconductor substrate comprises a reference position detection photodetector for detecting a signal in accordance with a reference position of the scale.

20. A head according to claim 19, wherein the two semiconductor substrates are arranged on two sides of the light source in a direction substantially perpendicular to a moving direction of the scale.
